(19) United States
(12) Patent Application Publication
(10) Pub. No.: US 2018/0274855 A1
(43) Pub. Date: Sep. 27, 2018

(54) TANK PRODUCTION SHAFT

(71) Applicant: TOYOTA JIDOSHA KABUSHIKI KAISHA, Toyota-shi (JP)

(72) Inventor: Naoki UEDA, Toyota-shi (JP)

(21) Appl. No.: 15/887,386

(22) Filed: Feb. 2, 2018

(30) Foreign Application Priority Data
Mar. 23, 2017 (JP) 2017-057355

(51) Int. Cl. F26B 3/30; B32B 1/02; B32B 27/18; B32B 27/38; H05B 3/48

(52) U.S. Cl. CPC F26B 3/30; B32B 1/02; B32B 27/18; B32B 27/38; H05B 2203/032; B32B 2262/106; B32B 2363/00; B32B 2439/00; H05B 3/48

(57) ABSTRACT

Provided is a tank production shaft that can improve the performance of a tank having a fiber-reinforced resin layer formed thereon through winding and heating of reinforcing fibers impregnated with thermosetting resin. The tank production shaft is adapted to support a tank having a fiber-reinforced resin layer formed thereon through winding and heating of reinforcing fibers impregnated with thermosetting resin. The tank production shaft has an outer peripheral portion formed of fiber-reinforced resin.

### CROSS REFERENCE TO RELATED APPLICATIONS

The present application claims priority from Japanese patent application JP 2017-057355 filed on Mar. 23, 2017, the content of which is hereby incorporated by reference into this application.

### BACKGROUND

### Technical Field

The present disclosure relates to a tank production shaft.

### Background Art

An invention related to a method and apparatus for producing a high-pressure gas tank is known (see JP 2011-230398 A). The apparatus for producing a high-pressure gas tank described in JP 2011-230398 A is used to produce a high-pressure gas tank that has a resin container as a liner and has a fiber-reinforced resin layer, which has been obtained by impregnating fibers with thermosetting resin and thermally curing the resin, formed on the outer periphery of the liner (see claim 4 and the like of JP 2011-230398 A). The production apparatus includes a means for pivotally supporting the liner and a thermally curing'means. The means for pivotally supporting the liner supports the liner having the fiber-reinforced resin layer, which is not thermally cured yet, formed on its outer periphery, and changes the internal pressure of the liner that is pivotally supported. The thermally curing means heats the liner that is pivotally supported by the means for pivotally supporting the liner so that the fiber-reinforced resin layer is thermally cured.

### SUMMARY

In the aforementioned production apparatus, the liner pivotally supported by the shaft, which is the means for pivotally supporting the liner, is heated by the thermally curing means so that the fiber-reinforced resin layer is thermally cured. However, since the heating by the thermally curing means is performed from the outer side of the liner that is the resin container, it is difficult to uniformly heat the inner side and the outer side of the liner. Meanwhile, if the shaft is metal, when the liner pivotally supported by the shaft is cooled after the fiber-reinforced resin layer is thermally cured, the amount of shrinkage of the shaft supporting the liner becomes greater than that of the fiber-reinforced resin layer on the outer periphery of the liner. Therefore, there is a high possibility that thermal stress may act on the fiber-reinforced resin layer on the outer periphery of the liner, which can degrade the performance of the high-pressure gas tank, such as fatigue resistance.

The present disclosure provides a tank production shaft that can improve the performance of a tank having a fiber-reinforced resin layer formed thereon through winding and heating of reinforcing fibers impregnated with thermosetting resin.

The tank production shaft of the present disclosure is a tank production shaft for supporting a tank, the tank having a fiber-reinforced resin layer formed thereon through winding and heating of reinforcing fibers impregnated with thermosetting resin, in which the shaft has an outer peripheral portion formed of fiber-reinforced resin.

The tank production shaft of the present disclosure can be used for a method for producing a tank having a fiber-reinforced resin layer formed on its outer periphery, for example. The method includes a liner supporting step, a reinforcing fiber winding step, a heating step, and a cooling step. Hereinafter, the tank production shaft will be abbreviated to “shaft.”

In the liner supporting step, first, a liner that is a container forming an inner layer of a tank is prepared. As the liner, a liner having mouthpieces at opposite ends thereof can be used, for example. Of the mouthpieces at the opposite ends of the liner, at least one of the mouthpieces has an opening that allows the shaft to be inserted therethrough. In the liner supporting step the shaft is inserted through the opening of the mouthpiece of the liner so that the liner is supported by the shaft. The shaft is rotatably supported about its axis.

In the reinforcing fiber winding step, the shaft is rotated so that the liner supported by the shaft is rotated, and reinforcing fibers impregnated with thermosetting resin are repeatedly wound around the outer periphery of the liner. Accordingly, a reinforcing fiber layer, which contains thermosetting resin and reinforcing fibers, and can form a fiber-reinforced resin layer when the thermosetting resin is cured by heating, is formed on the outer periphery of the liner.

In the heating step, for example, the liner, which has the reinforcing fiber layer formed on its outer periphery through winding of reinforcing fibers impregnated with thermosetting resin, is heated from the outer side of the liner in a state in which the liner is supported by the shaft. Accordingly, the thermosetting resin impregnating the reinforcing fibers that form the reinforcing fiber layer formed on the outer periphery of the liner is cured, and so a fiber-reinforced resin layer is formed on the outer periphery of the liner.

Herein, the shaft has an outer peripheral portion formed of fiber-reinforced resin. Therefore, thermal expansion of the shaft inserted in the liner is suppressed, and so the difference between the amount of deformation of the shaft due to thermal expansion and the amount of deformation of the fiber-reinforced resin layer on the outer periphery of the liner due to thermal expansion can be minimized. Therefore, thermal stress that acts on the fiber-reinforced resin layer on the outer periphery of the liner can be reduced, and so the quality of the fiber-reinforced resin layer formed on the outer periphery of the tank can be improved. It should be noted that the shaft may include, on the inner side of its outer peripheral portion, a core made of resin or metal, or a hollow portion.

The shaft of the present disclosure may further include a heating portion to heat the outer peripheral portion. In such a case, in the heating step, the outer peripheral portion is heated by the heating portion, whereby the liner that is heated from its outer side can also be heated from its inner side by radiation heat of the outer peripheral portion. Accordingly, the inner side and the outer side of the liner can be heated uniformly in the heating step, and the curing time of the thermosetting resin can be reduced, and further, the thermosetting resin can be cured uniformly. Therefore, the quality of the fiber-reinforced resin layer formed on the outer periphery of'the tank can be improved.

The shaft of the present disclosure may further include a heat-generating portion on the inner side of the outer peripheral portion, the heat-generating portion being configured to generate heat when current is flowed therethrough. In such a case, in the heating step, current is flowed through the heat-generating portion to heat the outer peripheral portion, so that the liner that is heated from its outer side can also be heated from its inner side by radiation heat of the outer peripheral portion. Accordingly, in the heating step, the inner side and the outer side of the liner can be heated uniformly, and the curing time of the'thermosetting resin can be reduced, and further, the thermosetting resin can be cured uniformly. Therefore, the quality of the fiber-reinforced resin layer formed on the outer periphery of the tank can be improved.

In the cooling step, the tank that is supported by the shaft and has the fiber-reinforced resin layer formed on the outer periphery of the liner is cooled. Herein, the shaft has the outer peripheral portion formed of fiber-reinforced resin. Accordingly, the difference between the amount of deformation of the shaft inserted in the liner due to shrinkage when it is cooled and the amount of deformation of the fiber-reinforced resin layer formed on the outer periphery of the liner due to shrinkage when it is cooled can be minimized. Therefore, thermal stress that acts on the fiber-reinforced resin layer on the outer periphery of the liner is reduced, and so the quality of the fiber-reinforced resin layer formed on the outer periphery of the tank can be improved.

According to the present disclosure, a tank production shaft can be provided that can improve the performance of a tank having a fiber-reinforced resin layer formed thereon through winding and heating of reinforcing fibers impregnated with thermosetting resin.

### BRIEF DESCRIPTION OF THE DRAWINGS

FIG. 1 is a cross-sectional view showing the schematic configuration of a tank production shaft in accordance with. Embodiment 1 of the present disclosure;

FIG. 2 is a block diagram showing an example of a tank production system including the shaft shown in FIG. 1;

FIG. 3 is a flowchart showing an example of a tank production method that uses the shaft shown in FIG. 1;

FIG. 4 is a graph showing the relationship between the temperature of a tank and time in a heating step shown in FIG. 3;

FIG. 5 is a cross-sectional view showing the schematic configuration of a tank production shaft in accordance with Embodiment 2 of the present disclosure;

FIG. 6 is an enlarged cross-sectional view showing the schematic configuration of a shaft used for the conventional tank production system;

FIG. 7 is a graph showing the relationship between the temperature of a tank and time in the conventional tank production method; and

FIG. 8 is an enlarged cross-sectional view of a tank produced with the conventional tank production method.

### DETAILED DESCRIPTION

Hereinafter, an embodiment of a tank production shaft of the present disclosure will be described with reference to the drawings.

### Embodiment 1

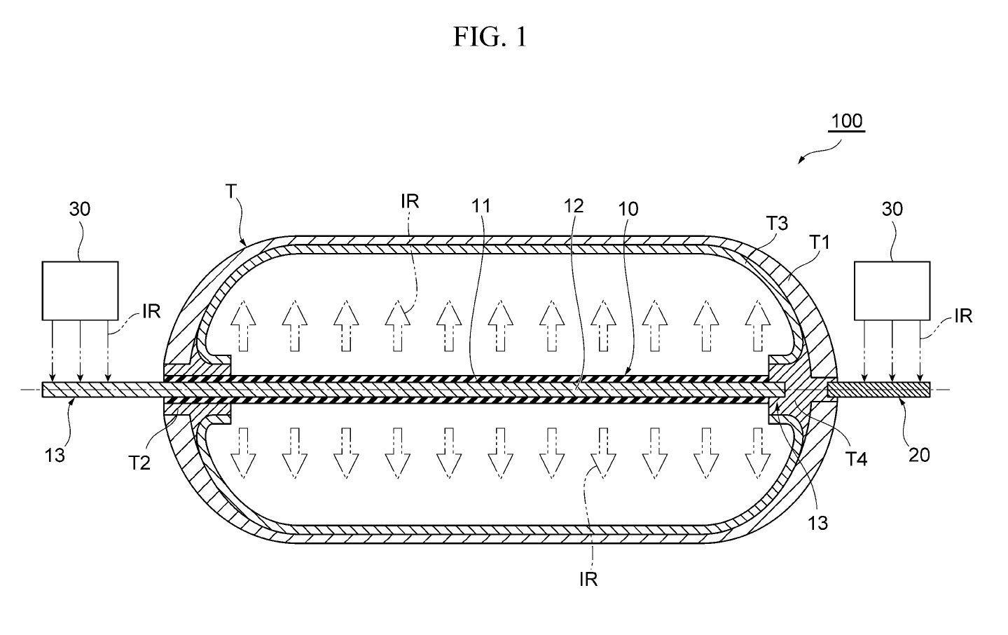

FIG. 1 is a cross-sectional view showing the schematic configuration of a tank production shaft 10 in accordance with Embodiment 1 of the present disclosure. In the following description, the tank production shaft 10 may be abbreviated to “shaft 10.”

The shaft 10 in this embodiment is the shaft 10 for supporting a tank T having a fiber-reinforced resin layer T1 formed thereon through winding and heating of reinforcing fibers impregnated with thermosetting resin. The shaft 10 is characterized by having an outer peripheral portion 11 made of fiber-reinforced resin. In the example shown in FIG. 1, the shaft 10 is used for a tank production system 100 for producing the tank T having the fiber-reinforced resin layer T1 on its outer periphery.

The outer peripheral portion 11 of the shaft 10 is, for example, a fiber-reinforced resin layer made of carbon fiber-reinforced resin (CFRP: carbon fiber-reinforced plastics) that is formed by winding carbon fibers impregnated with epoxy resin around the outer periphery of a core 12 and heating them. The outer peripheral portion 11 of the shaft 10 can be formed through filament winding (FW), for example.

In order to form the outer peripheral portion 11 of the shaft 10 through FW, for example, reinforcing fibers impregnated with thermosetting resin are wound around the outer periphery of the core 12 that forms the center of the shaft 10, and the thermosetting resin impregnating the reinforcing fibers wound around the outer periphery of the core 12 is heated so as to be cured. It should be noted that the outer peripheral portion 11 of the shaft 10 may also be formed by inserting the core 12 into a tubular fiber-reinforced resin member so as to cause the fiber-reinforced resin member to bond to the outer surface of the core 12 by heating it, for example.

As the material of the core 12, metal such as stainless steel is typically used. However, resin may also be used, for example. The core 12 may be a solid bar-like core, but may also be a hollow tubular core. As the thermosetting resin to impregnate the reinforcing fibers, not only epoxy resin, but also polyester resin or polyamide resin can be used, for example. As the reinforcing fibers, not only carbon fibers, but also glass fibers can be used, for example.

The shaft 10 is configured to be inserted into the tank T via an opening of an inlet-side mouthpiece T2 provided at one end of the tank T, for example, so as to rotatably support the tank T about the axis. More specifically, the shaft 10 has at its opposite ends no outer peripheral portion 11 made of fiber-reinforced resin, but has core exposed portions 13 in which the core 12 is exposed, for example.

The shaft 10 is inserted into the liner T3, which is an inner layer of the tank T, through the opening of the inlet-side mouthpiece T2 provided at one end of the liner T3. The shaft 10 is configured such that when inserted into the liner T3, for example, the core exposed portion 13 on the distal end side engages with the inner side of an end-side mouthpiece T4 provided at the other end of the liner T3, and the core exposed portion 13 on the proximal end side is located outside of the tank T. In addition, a bar-like FW jig 20 made of metal is adapted to engage with the outer side of the end-side mouthpiece T4, for example. Accordingly, it is possible to support the core exposed portion 13 on the proximal end side of the shaft 10 and the FW jig 20 engaged with the outer side of the end-side mouthpiece T4, thereby rotatably supporting the liner T3 about the axis of the shaft 10.

It should be noted that the end-side mouthpiece T4 may also have an opening to allow the shaft 10 to be inserted therethrough as with the inlet-side mouthpiece T2. In such a case, the core exposed portion 13 at the distal end side of the shaft 10, which has been inserted into the liner T3 through the opening of the inlet-side mouthpiece T2, is allowed to further protrude to the outside of the liner T3 through the opening of the end-side mouthpiece T4. Accordingly, the core exposed portions 13 at opposite ends of the shaft 10, which penetrates the Liner T3, are located outside of the tank T, and so the core exposed portions 13 at opposite ends of the shaft 10 can be supported and the liner T3 can be rotatably supported about the axis of the shaft 10.

Herein, the outer peripheral portion 11, which is made of fiber-reinforced resin, of the shaft 10 can be formed such that it covers the outer peripheral surface of the core 12 facing the internal space of the liner T3. In addition, the outer peripheral portion 11 of the shaft 10 can be formed such that it covers the outer peripheral surface of the core 12 facing the inner peripheral surface of the opening of the inlet-side mouthpiece T2 through which the shaft 10 is inserted. Likewise, when the end-side mouthpiece T4 has an opening, the outer peripheral portion 11 of the shaft 10 can be formed such that it covers the outer peripheral surface of the core 12 facing the inner peripheral surface of the opening of the end-side mouthpiece T4 through which the shaft 10 is inserted. Further, the outer peripheral portion 11 of the shaft 10 may also be formed such that it covers a part of the outer peripheral surface of the core 12 that protrudes from the opening of the inlet-side mouthpiece T2 or the opening of the end-side mouthpiece T4.

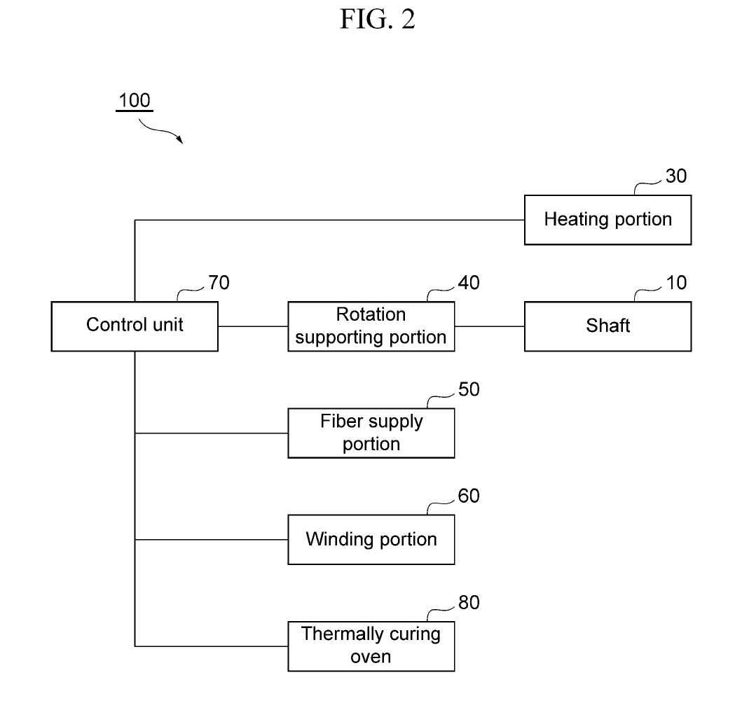

FIG. 2 is a block diagram of the tank production system 100 including the shaft 10 shown in FIG. 1. The tank production system 100 includes, for example, the shaft 10 shown in FIG. 1 and a heating portion 30 for heating the outer peripheral portion 11 of the shaft 10. It should be noted that the heating portion 30 may be a constituent element of the shaft 10. That is, the shaft 10 in this embodiment may include the heating portion 30 for heating the outer peripheral portion 11. However, the heating portion 30 is not an essential configuration of the tank production system 100 and therefore may be omitted.

The heating portion 30 heats the core exposed portion 13 of the shaft 10, which protrudes to the outside of the liner T3 from the opening of the inlet-side mouthpiece T2, and the FW jig 20, which engages with the outer side of the end-side mouthpiece T4, through irradiation with infrared rays IR. In addition, although not shown in FIG. 1, the tank production system 100 may include a rotation supporting portion 40, a fiber supply portion 50, a winding portion 60, a control unit 70, and a thermally curing oven 80, as shown in FIG. 2.

The rotation supporting portion 40 rotatably supports the shaft 10 about its axis. The rotation supporting portion 40 supports, for example, the core exposed portion 13 on the proximal end side of the shaft 10 that protrudes from the opening of the inlet-side mouthpiece T2 of the liner T3, and the FW jig 20 engaged with the outer side:of the end-side mouthpiece T4 of the liner T3. The rotation supporting portion 40 rotates the shaft 10 and the FW jig 20 about the axis, thereby rotating the liner T3 about the axis of the shaft 10.

The fiber supply portion 50 feeds bundles of reinforcing fibers impregnated with thermosetting resin. The winding portion 60 winds the reinforcing fibers fed by the fiber supply portion 50 around the outer periphery of the liner T3. The control unit 70 controls the rotation supporting portion 40, the fiber supply portion 50, and the winding portion 60 such that the reinforcing fibers are wound around the outer periphery of the liner T3 through helical winding or hoop winding, for example. The thermally curing oven 80 is controlled by the control unit 70 to heat the liner T3, which is supported by the shaft 10 and the FW jig 20 and has wound on its outer periphery reinforcing fibers impregnated with the thermosetting resin, from the outer side of the liner T3.

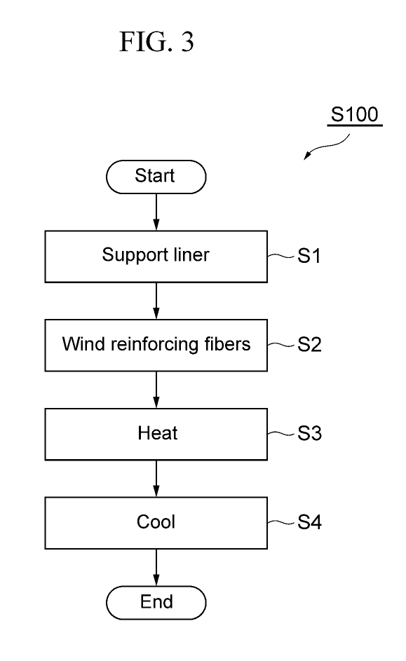

Next, the operation of the shaft 10 in this embodiment will be described with reference to an example of a tank production method that uses the shaft 10 in this embodiment. FIG. 3 is a flowchart showing an example of a tank production method 5100 that uses the shaft 10 shown in this embodiment.

The shaft 10 in this embodiment is used for the tank production system 100 for producing a high-pressure gas tank, such as a high-pressure hydrogen tank, using FW, for example, and for the tank production method S100 that uses the tank production system 100. The tank production method 5100 includes, for example, a liner supporting step S1, a reinforcing fiber winding step S2, a heating step S3, and a cooling step S4.

In the liner supporting step S1, the liner T3, which is a container that forms an inner layer of the tank T, is prepared. As described above, the liner T3 has at one end the inlet-side mouthpiece T2 with an opening, and has at the other end the end-side mouthpiece T4 without an opening, for example. Next, the shaft 10 is inserted through the opening of the inlet-side mouthpiece T2 of:the liner T3 so that the liner T3 is supported by the shaft 10.

More specifically, for example, the distal end side of the shaft 10 is inserted through the opening of the inlet-side mouthpiece T2 provided at one end of the liner T3, so that the core exposed portion 13 at the distal end side of the shaft 10 is caused to engage with the inner side of the end-side mouthpiece T4 provided at the other end of the liner T3. In addition, the bar-like FW jig 20 made of metal is caused to engage with the outer side of the end-side mouthpiece T4. Further, the core exposed portion 13 at the proximal end side of the shaft 10 located outside of the inlet-side mouthpiece T2, which is provided at one end of the liner T3, and the FW jig 20 engaged with the outer side of the end-side mouthpiece T4, which is provided at the other end of the liner T3, are supported by the rotation supporting portion 40 of the tank production system 100. Accordingly, the liner T3 can be rotatably supported about the axis of the shaft 10 by the shaft 10 and the FW jig 20.

It should be noted that when the end-side mouthpiece T4 has an opening, the core exposed portion 13 at the distal end side of the shaft 10, which has been inserted into the liner T3 through the opening of the inlet-side mouthpiece T2, is further caused to protrude to the outside of the liner T3 through the opening of the end-side mouthpiece T4. Then, the core exposed portions 13 at the opposite ends of the shaft 10, which penetrates the liner T3, are supported by the rotation supporting portion 40 of the tank production system 100. Accordingly, the liner T3 can be rotatably supported about the axis of the shaft 10 by the shaft 10.

In the reinforcing fiber winding step S2, the control unit 70 of the tank production system 100 controls the rotation supporting portion 40, the fiber supply portion 50, and the winding portion 60. Then while the liner T3 is rotated with the shaft 10 and the FW jig 20 rotated by the rotation supporting portion 40, reinforcing fibers impregnated with thermosetting resin are fed from the fiber supply portion 50, so that the reinforcing fibers are repeatedly wound around the outer periphery of the liner T3 by the winding portion 60. Accordingly, a reinforcing fiber layer, which contains thermosetting resin and reinforcing fibers and can form the fiber-reinforced resin layer T1 when the thermosetting resin is cured by heating, is formed on the outer periphery of the liner T3.

In the heating step S3, the liner T3, which has the reinforcing fiber layer formed on its outer periphery through winding of the reinforcing fibers impregnated with thermosetting resin, is stored in the thermally curing oven 80 in a state in which the liner T3 is supported by the shaft 10 and the FW jig 20. Then, the thermally curing oven 80 is controlled by the control unit 70 so that the liner 13 is heated from its outer side in the thermally curing oven 80. Accordingly, the thermosetting resin impregnating the reinforcing fibers, which form the reinforcing fiber layer formed on the outer periphery of the liner T3, is cured, and so the fiber-reinforced resin layer T1 is formed on the outer periphery of the liner T3.

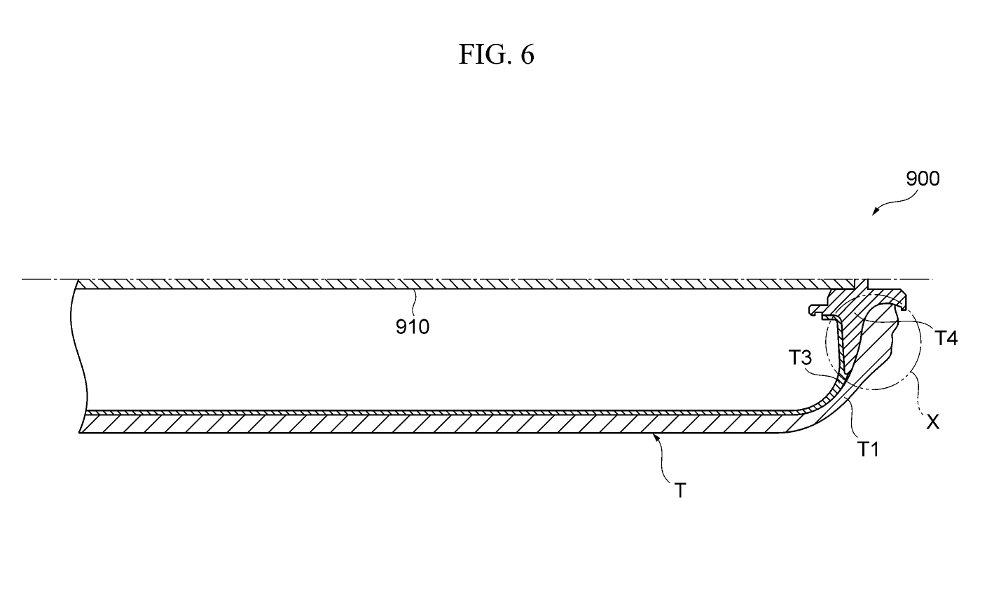

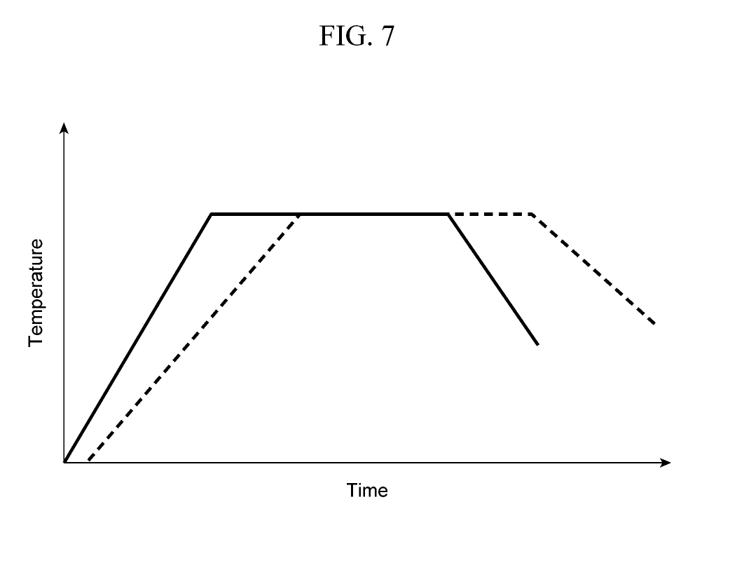

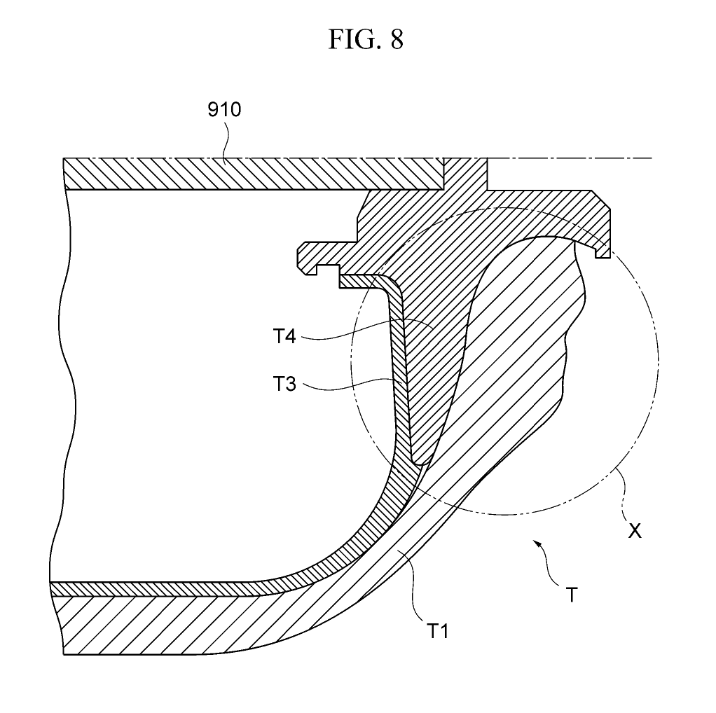

FIG. 6 is an enlarged cross-sectional view showing the schematic configuration of a shaft 910 used for the conventional tank production system 900. FIG. 7 is a graph showing the relationship between the temperature of the tank T and time in the conventional tank production method that uses the conventional tank production system 900 shown in FIG. 6. In FIG. 7, the relationship between the temperature of the outer side of the tank T, that is, the fiber-reinforced resin layer T1 and time in the conventional tank production method is indicated by the solid line, and the relationship between the temperature of the inner side of the tank T, that is, the liner T3 and time is indicated by the dashed line. FIG. 8 is an enlarged cross-sectional view of the tank T produced with the conventional tank production method.

As shown in FIG. 6, in the conventional tank production system 900, the liner T3 is supported by the shaft 910 made of metal, and the liner T3 is heated from its outer side so that the fiber-reinforced resin layer T1 is formed on the outer periphery of the liner T3. However, when the liner T3 is heated from its outer side, the difference between the temperature on the outer side of the tank T indicated by the solid line and the temperature on the inner side of the tank T indicated by the dashed line becomes large as shown in FIG. 7. Therefore, there is concern that not only does it take a long time to cure the fiber-reinforced resin layer T1, but also the fiber-reinforced resin layer T1 cures non-uniformly, which can degrade the quality such as fatigue properties.

If the shaft 910, which is a means for pivotally supporting the liner, is metal, when the liner T3 that is pivotally supported by the shaft 910 is cooled after the fiber-reinforced resin layer T1 is thermally cured, the amount of shrinkage of the shaft 910 supporting the liner T3 becomes greater than that of the fiber-reinforced resin layer T1 on the outer periphery of the liner T3. Therefore, as indicated by the X portion in FIG. 8, there is a high possibility that thermal stress may act on the fiber-reinforced resin layer T1 on the outer periphery of the liner T3, which can degrade the performance of the tank T, such as fatigue resistance, when the tank T is used as a high-pressure gas tank.

In contrast, the shaft 10 in this embodiment has the outer peripheral portion 1 made of fiber-reinforced resin. Therefore, as mentioned above, even if metal such as stainless steel that has a higher coefficient of linear expansion than that of the fiber-reinforced resin layer T1 of the liner T3 is used as the material of the core 12 of the shaft 10 as described above, thermal expansion of the shaft 10 can be suppressed by the outer peripheral portion 11 formed on the outer periphery of the core 12. Accordingly, the difference between the amount of deformation of the shaft 10 due to thermal expansion and the amount of deformation of the fiber-reinforced resin layer T1 on the outer periphery of the liner T3 due to thermal expansion can be minimized. Therefore, thermal stress that acts on the fiber-reinforced resin layer T1 on the outer periphery of the liner T3 decreases, and so the quality of the fiber-reinforced resin layer T1 formed on the outer periphery of the tank T can be improved.

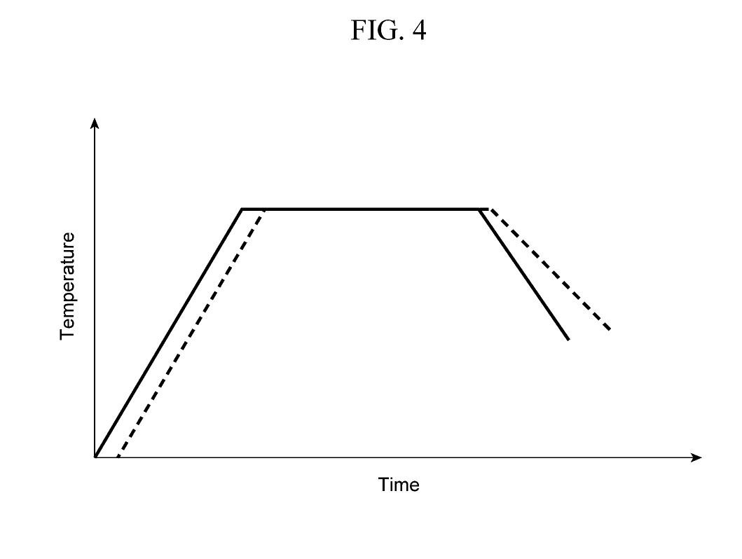

FIG. 4 is a graph showing the relationship between each of the temperature of the inner side and the outer side of the tank T and time in the heating step S3 shown in FIG. 3. In FIG. 4, the relationship between time and the temperature of the outer side of the tank T, that is, the reinforcing fiber layer on the outer periphery of the liner T3 and the fiber-reinforced resin layer T1 is indicated by the solid line, and the relationship between the temperature of the inner side of the tank T, that is, the liner T3, which is the inner layer of the tank T, and time is indicated by the dashed line.

The tank production system 100 and the shaft 10 in this embodiment have the heating portion 30 for heating the outer peripheral portion 11. Therefore, in the heating step S3, the core exposed portion 13 of the shaft 10 can be irradiated with infrared rays IR by the heating portion 30, and so the outer peripheral portion 11 of the shaft 10 can be heated by the core 12 heated by the infrared rays IR. Further, the FW jig 20 is irradiated with infrared rays IR by the heating portion 30, and so the end-side mouthpiece T4 provided at an end of the liner T3 can be heated by the FW jig 20 heated by the infrared rays IR.

Further, the core 12 of the shaft 10 engaged with the inner side of the end-side mouthpiece T4 is heated by the end-side mouthpiece T4 heated by the FW jig 20, and so the outer peripheral portion 11 can be heated by the core 12 heated by the end-side mouthpiece T4. In this manner, the outer peripheral portion 11 of the shaft 10 heated by the core 12, which has been heated directly or indirectly by the heating portion 30, radiates the infrared rays IR and heats the liner T3 from its inner side. As the outer peripheral portion 11 of the shaft 10 is heated indirectly by the heating portion 30 as described above, the liner T3 that is heated from its outer side within the thermally curing oven 80 can also be heated from its inner side by radiation heat of the outer peripheral portion 11.

Accordingly, in the heating step S3, the inner side and the outer side of the tank T can be heated more uniformly than those of the conventional tank. Therefore, in FIG. 4, the difference between the temperature on the outer side of the tank T indicated by the solid line and the temperature on the inner side of the tank T indicated by the dashed line can be reduced than that when the conventional production method shown in FIG. 7 is used. Therefore, not only does the curing time of the thermosetting resin become shorter, but also the thermosetting resin can be cured uniformly, and so the quality of the fiber-reinforced resin layer T1 formed on the outer periphery of the tank T can be improved.

In the cooling step S4, the tank T that is supported by the shaft 10 and has the fiber-reinforced resin layer T1 formed on the outer periphery of the liner T3 is cooled. Herein, the shaft 10 has the outer peripheral portion 11 formed of fiber-reinforced resin. Accordingly, the difference between the amount of deformation of the shaft 10 inserted in the liner T3 due to shrinkage when it is cooled and the amount of deformation of the fiber-reinforced resin layer T1 formed on the outer periphery of the liner T3 due to shrinkage when it is cooled can be minimized. Therefore, as shown in FIG. 8, thermal stress that acts on the fiber-reinforced resin layer T1 on the outer periphery of the liner T3 that may become large in the conventional tank production system decreases, and so the quality of the fiber-reinforced resin layer T1 formed on the outer periphery of the tank. T can be improved.

As described above, according to this embodiment, the tank production shaft 10 that can improve the performance of the tank T, which has the fiber-reinforced resin layer T1 formed thereon through winding and heating of reinforcing fibers impregnated with thermosetting resin, as well as the tank production system 100 and the tank production method S100 that use the shaft 10 can be provided.

### Embodiment 2

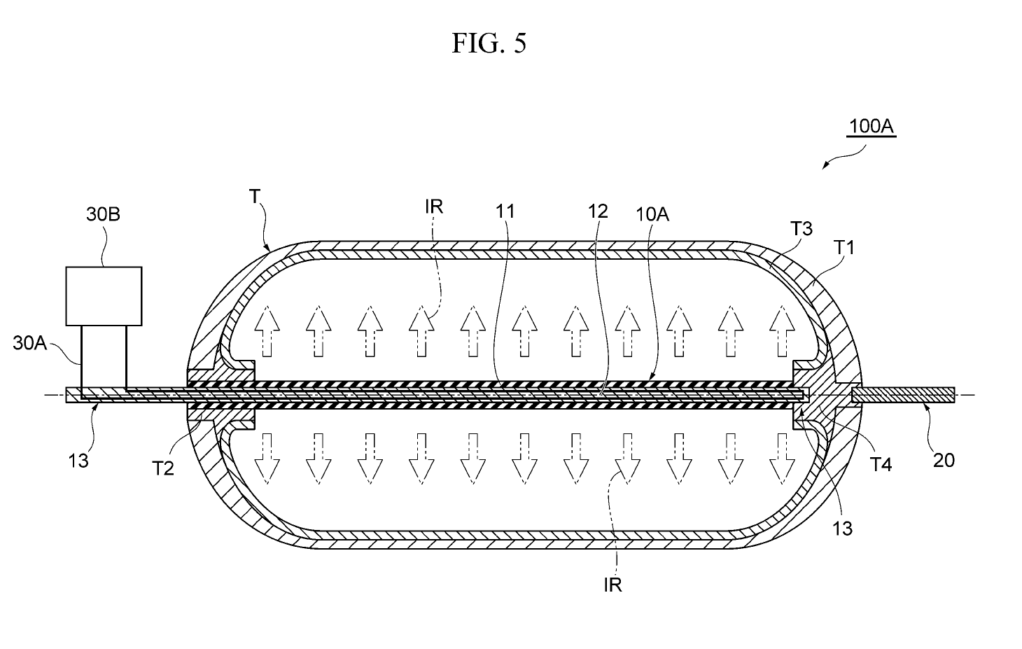

Next, the tank production shaft in accordance with Embodiment 2 of the present disclosure will be described with reference to FIG. 5 and also with the assistance of FIGS. 2 to 4. FIG. 5 is a cross-sectional view showing the schematic configuration of the shaft 10A in accordance with Embodiment 2 of the present disclosure, and the tank production system 100A including the shaft 10A.

The shaft 10A in this embodiment has, instead of the heating portion 30 for heating the outer peripheral portion 11 shown in FIG. 1, a heat-generating portion 30A that generates heat when current is flowed therethrough, on the inner side of the outer peripheral portion 11. Since the other configurations of the shaft 10A in this embodiment are similar to those of the shaft 10 in Embodiment 1 described above, the same portions are denoted by the same reference numerals and the description thereof will be omitted.

As shown in FIG. 5, the shaft 10A includes, on the inner side of the outer peripheral portion 11, the heat-generating portion 30A that is formed of a heating coil, such as a tungsten filament or an iron chromium wire, and that easily generates heat when current is flowed therethrough. The heat-generating portion 30A is connected to a power supply 30B at the core exposed portion 13 on the proximal end side of the shaft 10A, for example. The heat-generating portion 30A is wound around the outer peripheral surface of the core 12, for example, and is disposed between the core 12 and the outer peripheral portion 11.

According to such a configuration, in the heating step S3 shown in FIG. 3, the heat-generating portion 30A connected to the power supply 30B is caused to generate heat when current is flowed therethrough, and so the outer peripheral portion 11 can be heated by the heat-generating portion 30A. The outer peripheral portion 11 of the shaft 10A heated by the, heat-generating portion 30A heats the liner T3 from its inner side by radiating infrared rays IR. As described above, as the outer peripheral portion 11 of the shaft 10A is heated directly by the heat-generating portion 30A, the liner T3 that is heated from its outer side within the thermally curing oven 80 can also be heated from its inner side by radiation heat of the outer peripheral portion 11.

Accordingly, in the heating step S3, the inner side:and the outer side of the tank T can be heated more uniformly than those of the conventional tank. Therefore, as with the shaft 10 in Embodiment 1, the difference between the temperature on the outer side of the tank T indicated by the solid line and the temperature on the inner side of the tank T indicated by the dashed line in FIG. 4 can be reduced than that when the conventional production method shown in FIG. 7 is used. Therefore, not only does the curing time of the thermosetting resin become shorter, but also the thermosetting resin can be cured uniformly, and so the quality of the fiber-reinforced resin layer T1 formed on the outer periphery of the tank T can he improved.

Although the embodiments of the present disclosure have been described in detail above with reference to the drawings, the specific configuration is not limited thereto, and any design changes and the like that are within the spirit and scope of the present disclosure are all included in the present disclosure.

### DESCRIPTION OF SYMBOLS

10 Shaft (tank production shaft)
11 Outer peripheral portion
30 Heating portion
30A Heat-generating portion
T Tank.
T1 Fiber-reinforced resin layer

What is claimed is:

1. A tank production shaft for supporting a tank, the tank having a fiber-reinforced resin layer formed thereon through winding and heating of reinforcing fibers impregnated with thermosetting resin, wherein the shaft has an outer peripheral portion formed of fiber-reinforced resin.

2. The tank production shaft according to claim 1, further comprising a heating portion configured to heat the outer peripheral portion.

3. The tank production shaft according to claim 1, further comprising a heat-generating portion on an inner side of the outer peripheral portion, the heat-generating portion being configured to generate heat when current is flowed therethrough.
